(19) United States
(12) Patent Application Publication
(10) Pub. No.: US 2026/0278493 A1
(43) Pub. Date: Sep. 17, 2026

(54) Machine Learning Techniques For Generating Skill Hierarchies

(71) Applicant: Oracle International Corporation, Redwood Shores, CA (US)

(72) Inventors: Karempudi V. Ramarao, San Ramon, CA (US); Cody Kingham, Georgetown, TX (US); Praveenkumar Reddy Vankireddy, Chester Springs, PA (US); Rajiv Kumar, Austin, TX (US)

(73) Assignee: Oracle International Corporation, Redwood Shores, CA (US)

(21) Appl. No.: 19/076,673

(22) Filed: Mar. 11, 2025

(51) Int. Cl. G06Q 10/0631; G06F 16/901; G06N 3/045

(52) U.S. Cl. CPC G06Q 10/063112; G06F 16/9024; G06N 3/045

(57) ABSTRACT

Techniques for using machine learning to generate skill hierarchies are disclosed. A system generates a graph that models a set of skills, including first and second nodes that represent first and second subsets of the skills. The system uses a model to determine that the first and second nodes are candidates to be connected by an edge in the graph, then uses a large language model to determine that the nodes are sufficiently similar to be connected by the edge. The system performs a minimum cut of a connected subgraph that includes the first and second nodes, to obtain first and second connected sub-subgraphs. The system uses generative artificial intelligence to determine (a) first and second node-level representatives for the first and second nodes and (b) a sub-subgraph-level representative skill. The system generates a skill hierarchy that includes the node-level and sub-subgraph-level representative skills.

### TECHNICAL FIELD

The present disclosure relates to machine learning. In particular, the present disclosure relates to machine learning techniques for generating skill hierarchies.

### BACKGROUND

Generative artificial intelligence (AI), also referred to as “GenAI,” is a type of machine learning system that generates new content such as text, images, audio, video, computer code, etc. GenAI systems are trained on large datasets and use machine learning models to generate outputs in response to prompts. Large language models (LLMs) are one example of GenAI systems.

While GenAI is useful in many contexts, it sometimes produces factual errors (referred to as “hallucinations”) and can produce otherwise imprecise and/or inaccurate output. GenAI does not perform well with problems that include large-scale computations (e.g., analyzing large datasets) and/or multi-step reasoning. Thus, GenAI performs particularly poorly when prompted to solve a multi-step problem involving a large dataset. Attempting to use GenAI to solve such problems consumes a considerable amount of computing resources (e.g., processor cycles), degrading overall system performance.

Skills are abilities and knowledge used to perform tasks effectively in a particular role or industry. Skills may include “hard and “soft” skills. Hard skills are technical skills such as programming languages, software tools, accounting principles, medical procedures, engineering practices, foreign languages, mathematical skills, etc. Soft skills are non-technical skills such as communication, problem-solving, teamwork and collaboration, time management, leadership, emotional intelligence, etc. Some non-limiting examples of situations in which an inventory of skills may be useful include the following:
a business unit may seek to form a team of employees with skills relevant to a particular task;
an executive may seek to evaluate if the company's workforce collectively has the skills needed to meet a long-term business objective;
a manager and/or team member may seek to identify gaps and/or opportunities for growth in the team member's skills; and/or
a university may seek to evaluate applicants against a set of desirable academic skills.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for generating a skill hierarchy using machine learning in accordance with one or more embodiments;

FIGS. 3A-3F illustrate an example of generating a skill hierarchy in accordance with one or more embodiments;

FIGS. 4A-4F illustrate another example embodiment of generating a skill hierarchy in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in an embodiment may be combined with features described in a different embodiment. In some examples, well-known structures and devices are described with reference to a block diagram form to avoid unnecessarily obscuring the present disclosure.
1. GENERAL OVERVIEW
2. HIERARCHY GENERATION ARCHITECTURE
3. GENERATING A SKILL HIERARCHY USING MACHINE LEARNING
4. EXAMPLE EMBODIMENT
5. COMPUTER NETWORKS AND CLOUD NETWORKS
6. MICROSERVICE APPLICATIONS
7. HARDWARE OVERVIEW
8. MISCELLANEOUS; EXTENSIONS

### 1. GENERAL OVERVIEW

As described herein, a skill hierarchy is a graph that organizes skills so that a subgraph of skills represents a subset of its parent skill. For example, computer programming may be divided into various sub-skills such as web development, backend programming, database programming, etc., with sub-skills being further divided into specific programming languages as sub-sub-skills. One or more embodiments generate a skill hierarchy that can be inspected at different levels of detail depending on the particular use case. For example, one use case may be concerned with specific hard skills (e.g., a particular programming language), while another use case may be more concerned with a broader category of skills (e.g., general technical literacy).

One or more embodiments generate a skill hierarchy using machine learning techniques that alleviate technical inefficiencies associated with LLMs. Specifically, one or more embodiments deconstruct the process of edge generation into multiple steps rather than using a single-prompt LLM for the entire process. For example, identifying candidate pairs of nodes to be connected by edges is a resource-intensive process on the order of O(n²), where n is the number of nodes. One or more embodiments use a model (which may not be an LLM) to identify candidate pairs of nodes to be connected by edges, then use an LLM to verify that the nodes proposed to be connected by edges are sufficiently similar. In this approach, the LLM works on the proposed set of edges without needing to examine every potential pair of nodes. This approach speeds up the edge generation process significantly, improving overall system performance by freeing computing resources for other uses. Reducing the computing resources needed to use LLMs also helps address the technical problem of LLMs having a significant environment impact because their consumption of computing resources translates to high energy expenditure.

One or more embodiments optimize the skill hierarchy using a recursive process to identify connected subgraphs with numbers of nodes that exceed a threshold. A connected subgraph can be split into two or more smaller connected sub-subgraphs. The system repeats this process recursively until none of the connected sub-subgraphs in the graph have numbers of nodes that exceed the threshold. One or more embodiments then use generative AI to determine (a) representative skills for each node, based on the skills associated with the node and (b) representative skills for each connected sub-subgraph, based on the representative skills for the nodes in the connected sub-subgraph. Reducing the sizes of connected subgraph and sub-subgraphs further improves the speed and accuracy of generating skill hierarchies, freeing additional computing resources for other uses.

One or more embodiments may be used to generate types of hierarchies other than skill hierarchies. In general, techniques discussed herein may be used to generate hierarchies of any distinct object or concept that can be logically divided and subdivided. For example, one or more embodiments may generate hierarchies that represent biological taxonomies, product categories, media classifications (e.g., musical genres), etc. Accordingly, techniques described herein should be construed as applying, mutatis mutandis, to generating other types of hierarchies.

One or more embodiments described in this Specification and/or recited in the claims may not be included in this General Overview section.

### 2. HIERARCHY GENERATION ARCHITECTURE

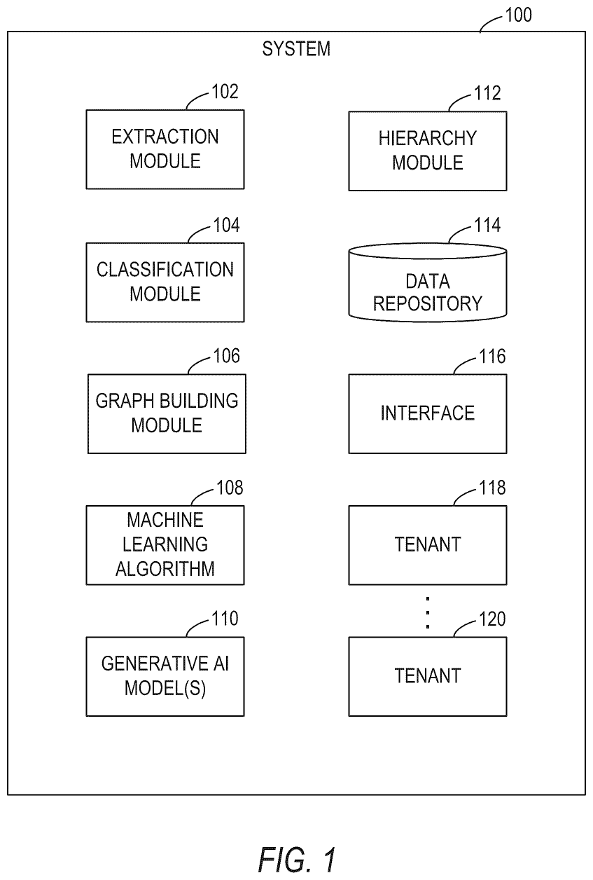

FIG. 1 illustrates a system 100 in accordance with one or more embodiments. As illustrated in FIG. 1, the system 100 includes an extraction module 102, a classification module 104, a graph building module 106, a machine learning algorithm 108, one or more generative AI models 110, a hierarchy module 112, a data repository 114, an interface 116, and one or more tenants 118, 120. In an embodiment, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

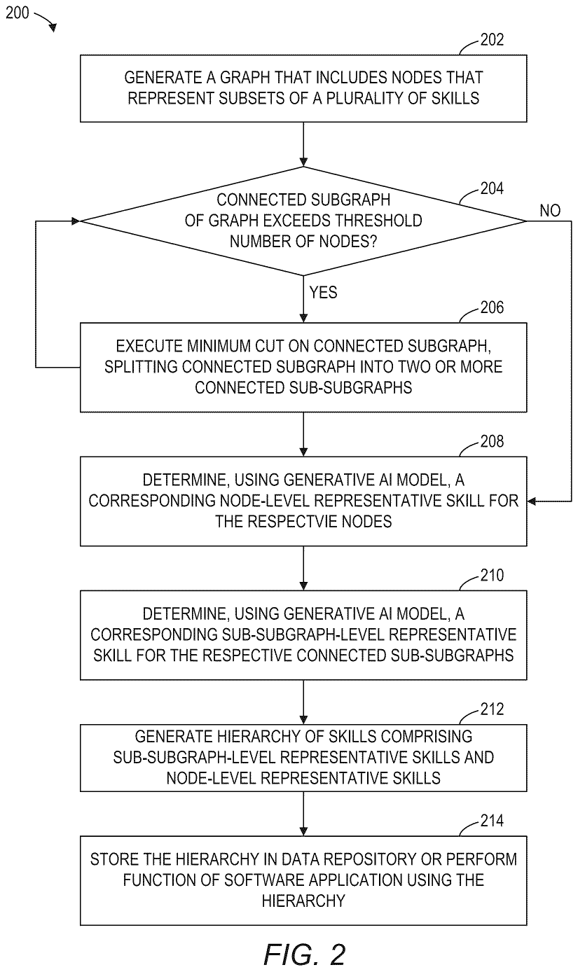

In an embodiment, system 100 refers to hardware and/or software configured to perform operations described herein for generating a skill hierarchy. Examples of operations for generating a skill hierarchy are described below with reference to FIG. 2. In an embodiment, system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In an embodiment, extraction module 102 refers to hardware and/or software configured to extract skills from one or more documents. In an embodiment, extraction module 102 accesses documents that are stored in the data repository 114 and extracts skills from the documents. The documents may include any kind of document that explicitly or implicitly includes information about skills. For example, the documents may include one or more job descriptions, résumés, course descriptions, transcripts, performance evaluations, digital messages (e.g., emails, instant messages, etc.), policies and procedures, whitepapers, digital presentations, etc.

In an embodiment, classification module 104 refers to hardware and/or software configured to generate subsets of skills from a set of extracted skills. To generate subsets of skills, classification module 104 may divide two or more of the extracted skills into different subsets of skills. In an embodiment, the classification module 104 is configured to use one or more generative AI models 110 to generate the subsets of skills.

In an embodiment, graph building module 106 refers to hardware and/or software configured to generate a graph that models skills. A graph is a data structure that represents a set of interconnected nodes connected by edges. The graph models relationships between different skills. In an embodiment, the graph includes one or more connected subgraphs. A subgraph is a portion of the graph that descends from a node “higher” in the hierarchy, i.e., fewer edges away from the root node. In a graph or subgraph, nodes are referred to as “connected” if the graph or subgraph includes a path of one or more edges between the nodes. An entire graph or subgraph is referred to as “connected” if all the nodes in the graph or subgraph are connected via one or more edges. In an embodiment, the graph building module 106 is configured to use one or more generative AI models 110 to generate the graph.

In an embodiment, a skill hierarchy may be implemented in a variety of ways. For example, the skill hierarchy may be implemented as a list of parents with pointers to children, a list of children with pointers to parents, or a list of nodes and a separate list of parent-child relations. Additionally or alternatively, the skill hierarchy may be implemented using one or more other kinds of data strutcure(s).

In an embodiment, machine learning algorithm 108 is configured to generate and/or train the generative AI model(s) 110. In some embodiments, the machine learning algorithm 108 is an algorithm that can be iterated to train a target model f that best maps a set of input variables to an output variable, using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, which in turn updates the target model f.

A machine learning algorithm 108 generates a target model f such that the target model f best fits the datasets of training data to the labels of the training data. Additionally, or alternatively, a machine learning algorithm 108 generates a target model f such that when the target model f is applied to the datasets of the training data, a maximum number of results determined by the target model f matches the labels of the training data. Different target models be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In an embodiment, the one or more generative AI models 110 include one or more LLMs. LLMs are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In accordance with one or more embodiments, transformers are composed of multiple layers including a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, the generative AI model(s) 110 handle textual data, converting input text into a format that the model can process. This typically involves tokenization, where the text is broken down into manageable pieces, such as words or sub-words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, the generative AI model(s) 110 may include steps, such as normalization, where the text is converted to a uniform case and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, the machine learning algorithm 108 is configured to adjust the parameters of the generative AI model(s) 110 through exposure to training data. This process utilizes optimization algorithms, such as stochastic gradient descent, to minimize the difference between the model's predictions and the actual desired outputs. The training process is computationally intensive, often requiring specialized hardware such as Graphics Processing Units (GPUs) or Tensor Processing Units (TPUs) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, the machine learning algorithm 108 assesses the performance of the generative AI model(s) 110 using metrics, such as perplexity, accuracy, and F1 score, depending on the specific tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In an embodiment, hierarchy module 112 refers to hardware and/or software configured to generate a skill hierarchy using a graph generated by graph building module 106. The skill hierarchy includes a hierarchical tree structure with a set of connected nodes. Each node in the tree can be connected to one or more children. Furthermore, each node, except for the root node (the top-most node in the tree hierarchy), is connected to a parent. In an embodiment, the hierarchy module 112 uses one or more generative AI models 110 to generate the skill hierarchy. Hierarchy module 112 may store the skill hierarchy in data repository 114 (discussed in further detail below) for subsequent use by one or more other components that are internal and/or external to the system 100.

In an embodiment, hierarchy module 112 is configured to use the skill hierarchy in a computer-based process. For example, the hierarchy module may be configured to use the skill hierarchy in a computer-based function of a human capital management (HCM) system. An HCM system is an integrated software suite that helps businesses manage their workforce. HCM systems can help with tasks such as recruiting, training, payroll, compensation, and performance management. Additionally or alternatively, one or more embodiments may use the skill hierarchy in other types of computer-based processes.

In an embodiment, data repository 114 is any type of storage unit and/or device (e.g., a file system, database, collection of tables, or any other storage mechanism) for storing data. Further, data repository 114 may include multiple different storage units and/or devices. The multiple different storage units and/or devices may or may not be of the same type or located at the same physical site. Further, data repository 114 may be implemented or executed on the same computing system as one or more of the other components of the system 100. Additionally, or alternatively, data repository 114 may be implemented or executed on a computing system separate from the other components of the system 100. Data repository 114 may be communicatively coupled to one or more of the other components of the system 100 via a direct connection or via a network.

In an embodiment, interface 116 refers to hardware and/or software configured to facilitate communications between a user and one or more components of the system 100. Interface 116 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 116 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 116 is specified in one or more other languages, such as Java, C, or C++.

In an embodiment, a tenant (such as tenant 118 and/or tenant 120) is a corporation, organization, enterprise or other entity that accesses a shared computing resource, such as the other components of system 100 illustrated in FIG. 1. In an embodiment, tenant 118 and tenant 120 are independent from each other. A business or operation of tenant 118 is separate from a business or operation of tenant 120.

### 3. GENERATING A SKILL HIERARCHY USING MACHINE LEARNING

FIG. 2 illustrates an example set of operations for generating a skill hierarchy using machine learning in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, a system (e.g., system 100 of FIG. 1) generates a graph that models a set of skills (Operation 202). The system may build the graph using information extracted from one or more documents that explicitly or implicitly include information about skills. In an embodiment in which the one or more documents are stored in a data repository, the system communicates with the data repository to access the one or more documents.

In an embodiment, the system extracts the skills from the document(s). The system may extract skills from the document(s) using a variety of techniques. The system may use a rule-based approach to identify skills in a document. For example, the system may search the document(s) to identify key words or phrases that correspond to skills in a mapping between key words/phrases and skills. Additionally or alternatively, the system may use a bootstrapping approach where the system uses a small set of manually identified skills to train an AI model, then uses the trained AI model to identify skill-related phrases in documents. Additionally or alternatively, the system may supply the document(s) as input to a generative AI model 110 that has been trained to identify skills in documents. Other techniques for extracting skills from documents are also within the scope of the present disclosure.

In an embodiment, the system groups the extracted skills into hard skills and soft skills categories. The system may use a generative AI model 110 to categorize the extracted skills into hard skills and soft skills. For example, the system may submit a prompt to an LLM to categorize the extracted skills into hard and soft skills. Other techniques for grouping the extracted skills into hard skills and soft skills are also within the scope of the present disclosure.

In an embodiment, the system subgroups closely related skills in the respective categories into subsets of closely related skills. The system may divide the skills into subsets of closely related skills using a variety of techniques. For example, the system may divide the skills into subsets based on syntactic similarity between skills in the respective subsets satisfying a criterion, such as a threshold level of syntactic similarity. The system may determine the number of common words or subphrases between a pair of skills and use that number as a metric of syntactic similarity. Additionally or alternatively, the system may use an AI model to compute corresponding vector embeddings for the skills, then use a similarity measure (e.g., cosine similarity) to find the pairwise similarities among the embeddings. The system may group the skills based on the corresponding similarity measures. Additionally or alternatively, the system may submit a prompt that includes the skills to an LLM. The prompt instructs the LLM to group the semantically most similar skills into corresponding subsets. Other techniques for subgrouping skills into subsets are also within the scope of the present disclosure.

In an embodiment, the system adds nodes to the graph corresponding to respective subsets of skills, such that a single node in the graph corresponds to a single skill or subset of skills. The system generates edges between pairs of nodes in the graph based on their semantic similarity. Thus, the graph may include connected subgraphs of semantically similar skills, where the nodes of a subgraph are connected via edges but the individual connected subgraphs in the graph are not connected to the other connected subgraphs in the graph.

The system may generate edges between nodes in a variety of ways. For two nodes associated with respective subsets of skills, the system may identify skills that are present in both subsets of skills. The two nodes are sufficiently similar to be connected if the number of skills that they have in common exceeds a threshold value. Additionally or alternatively, the system may compute corresponding vector embeddings for the nodes (e.g., concatenating skills in a particular node into a single text string), then determine if the corresponding vector embeddings of the two nodes satisfy (e.g., meet or exceed) a threshold value. Additionally or alternatively, the system may submit a prompt to an LLM, including the nodes, that instructs the LLM to group the nodes based on semantic similarity.

As discussed above, identifying candidate pairs of nodes to be connected by edges is a resource-intensive process on the order of O(n²), where n is the number of nodes. One or more embodiments improve the performance of edge generation by using a separate model (which may not be an LLM) to compute vector embeddings for nodes. The model identifies candidate pairs of nodes to be connected by edges based on similarity of their vector embeddings. The system may use an LLM to verify if the identified candidate pairs of nodes should be connected by edges. For example, the system may generate vector embeddings for the nodes using a non-LLM model and compute similarity metrics (e.g., cosine similarities) for pairs of nodes. A pair of nodes is a candidate for being connected by an edge if the similarity metric satisfies (e.g., meets or exceeds) a threshold value. In an embodiment, the non-LLM model includes a sentence transformer. A sentence transformer is a deep learning model that captures the meaning of a sentence or text fragment as a fixed-length vector. Other types of non-LLM models are also within the scope of the present disclosure.

In an embodiment, the system verifies the edge placement for the identified candidate pairs of nodes by using an LLM to check if the two nodes in the candidate pairs satisfy one or more similarity criteria. The system adds or retains edges between pairs of nodes that have been verified as satisfying the one or more similarity criteria. In this approach, the LLM can be called once per candidate edge rather than for each pair of nodes. Reducing the number of possible edges that the LLM needs to consider improves the speed of the edge generation.

In an embodiment, the system determines if a connected subgraph of the graph exceeds a threshold number of nodes (Operation 204). The system may count the number of nodes in the connected subgraph and compare the number of nodes to the threshold number of nodes.

In an embodiment, if a connected subgraph exceeds the threshold number of nodes, the system executes a minimum cut of the connected subgraph to split the connected subgraph into two or more connected sub-subgraphs (Operation 206). A cut is a partition of the vertices of a graph into two non-empty, disjoint subsets. A minimum cut is a cut for which the size or weight of the cut is not larger than the size of any other cut. The system may execute the minimum cut of the connected subgraph using a variety of minimum cut algorithms. For example, the system may use the Stoer-Wagner algorithm. Other minimum cut algorithms are also within the scope of the present disclosure. Because generative AI models have difficulty processing a relatively large number of skills and correctly identifying a single representative skill for those skills, splitting a large connected subgraph into smaller sub-subgraphs improves the performance of processing the connected components of the graph.

In an embodiment, the system further uses the minimum cut algorithm to determine if the connected sub-subgraphs exceed the threshold number of nodes (Operation 204). The system may recursively execute a minimum cut algorithm on connected subgraphs or the resulting connected components (e.g., sub-subgraphs) of any minimum cut operations until the connected subgraph or component no longer exceeds the threshold number of nodes.

In an embodiment, for the nodes of a connected sub-subgraph, the system determines corresponding node-level representative skills. The system may determine the node-level representative skills using a generative AI model (Operation 208). The node-level representative skill for a particular node represents the skills associated with that particular node. The generative AI model may be an LLM. The system may submit a prompt to the LLM instructing the LLM to generate the corresponding node-level representative skills for the nodes of the connected sub-subgraph.

In an embodiment, the system uses a generative AI model to determine sub-subgraph-level representative skills for connected sub-subgraphs based on the node-level representative skills of the nodes in the respective connected sub-subgraphs (Operation 210). A sub-subgraph-level representative skill represents the collection of node-level representative skills for the nodes in that particular connected sub-subgraph. In an embodiment, the system uses an LLM to determine the sub-subgraph-level representative skills. The system may submit a prompt to the LLM instructing the LLM to generate the sub-subgraph-level representative skills for the connected sub-subgraphs. The system may use the same generative AI model to generate node-level representative skills and sub-subgraph-level representative skills. Alternatively, the system may use different models for the two operations.

In an embodiment, the system generates a skill hierarchy that includes the sub-subgraph-level representative skills and the node-level representative skills (Operation 212). A branch in the skill hierarchy may include three or more levels: a lowest level that includes specific skills, a next-higher level that includes a corresponding node-level representative skills, and a next-higher level that includes a sub-subgraph-level representative skill.

In an embodiment, when generating the skill hierarchy, the system reconstructs the original connected subgraph by reconnecting nodes of the connected sub-subgraphs that were disconnected by the minimum cut(s). The system may also determine a subgraph-level representative skill for the reconstructed connected subgraph based on the sub-subgraph representative skills.

The system may use a generative AI model to determine the subgraph-level representative skill for the reconstructed connected subgraph. This generative AI model may be an LLM. The system may submit a prompt to the LLM instructing the LLM to generate the subgraph-level representative skill for the reconstructed original connected subgraph based on the corresponding sub-subgraph representative skills. This generative AI model may be the same model used to generate one or both of the node-level representative skills and/or sub-subgraph-level representative skills. Alternatively, this generative AI model may be a different model. In an embodiment, the system adds the subgraph-level representative skill to the skill hierarchy as a parent of the sub-subgraph-level representative skills of the connected sub-subgraphs of the reconstructed original connected subgraph.

In an embodiment, the system stores the skill hierarchy in a data repository and/or performs a software function using the skill hierarchy (Operation 214). For example, the system may store the skill hierarchy in a data repository for subsequent use by one or more components that is/are internal and/or external to the system. The system uses the skill hierarchy in a computer-based function of an HCM system. For example, the HCM system may determine if a user profile managed by the HCM system identifies a particular skill in the skill hierarchy. Responsive to determining if the user profile identifies the particular skill, the HCM system may perform one or more skill-related HCM functions associated with the user profile. For example, the HCM system may identify skills in the skill hierarchy that are closely related to a particular skill identified in the user profile but that are not represented in the user profile, indicating that the user associated with the user profile does not have those identified skills. The HCM may display or otherwise electronically communicate (a) an indication that the user lacks those identified skills and/or (b) a recommendation that the user to acquire those identified skills. Additionally or alternatively, one or more embodiments may use the skill hierarchy to perform other types of computer-based functions and processes.

### 4. EXAMPLE EMBODIMENT

Detailed examples are described below for purposes of clarity. Components and/or operations described below should be understood as one specific example that may not be applicable to certain embodiments. Accordingly, components and/or operations described below should not be construed as limiting the scope of any of the claims.

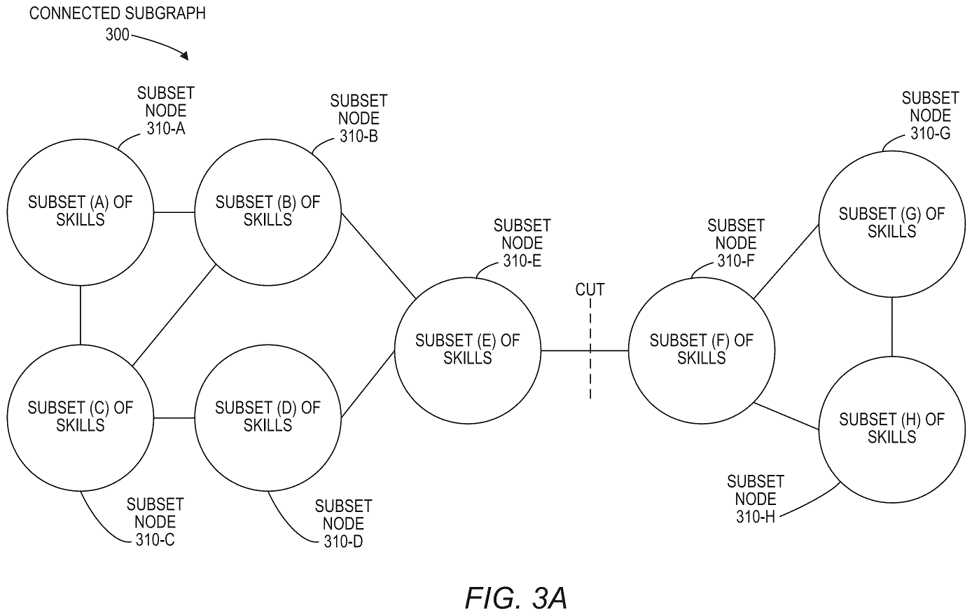

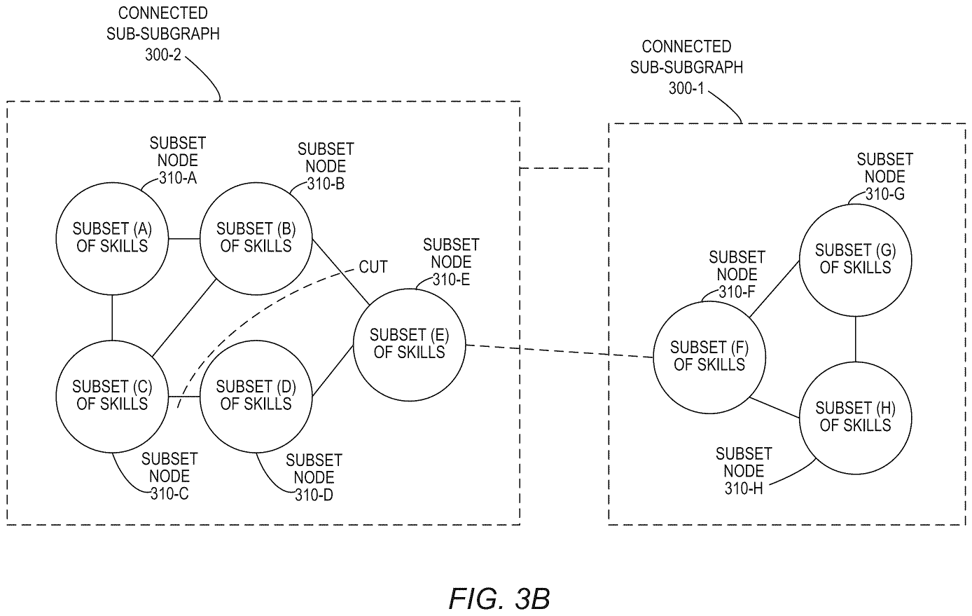

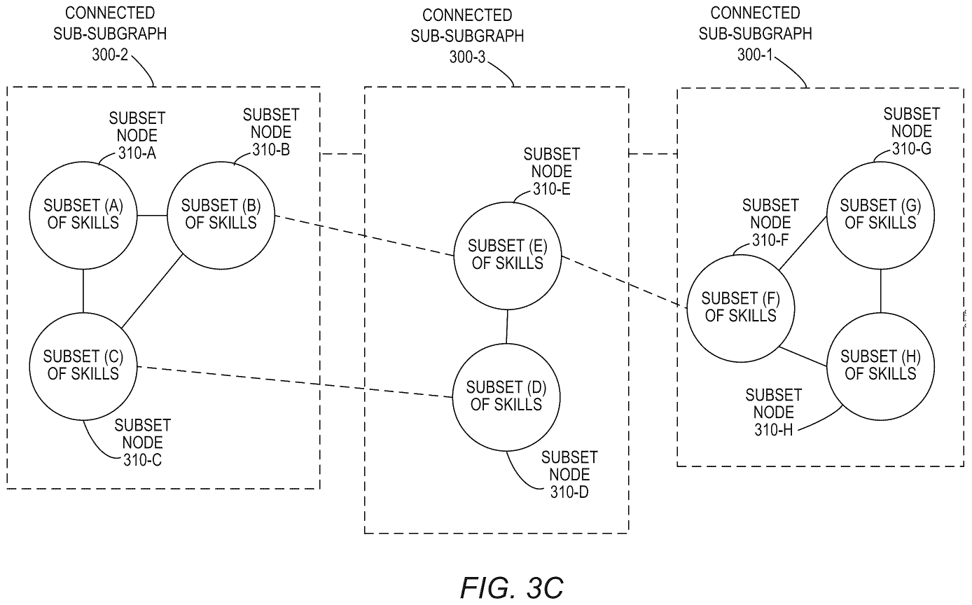

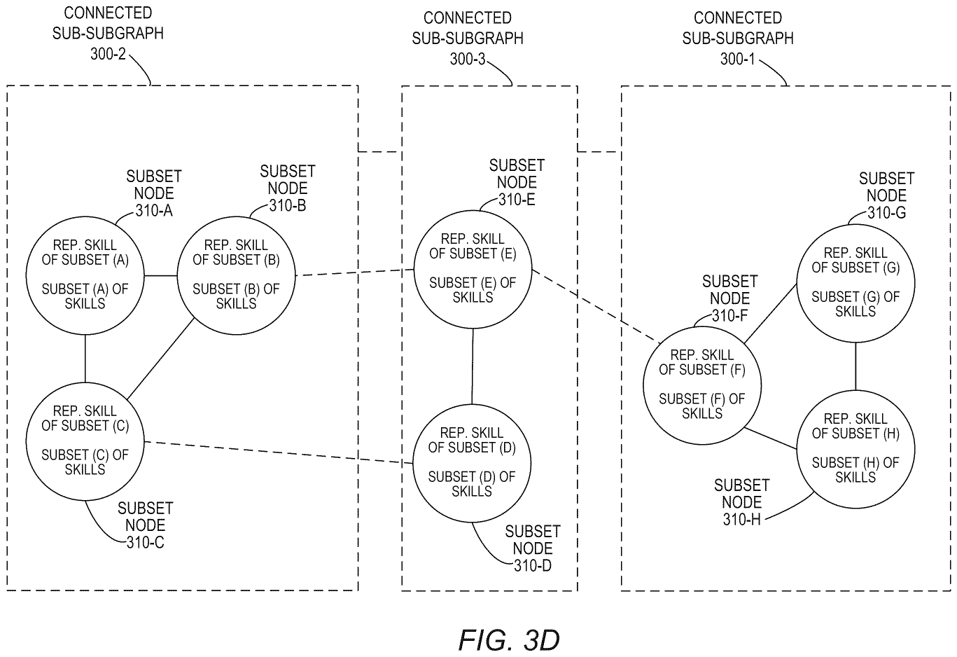

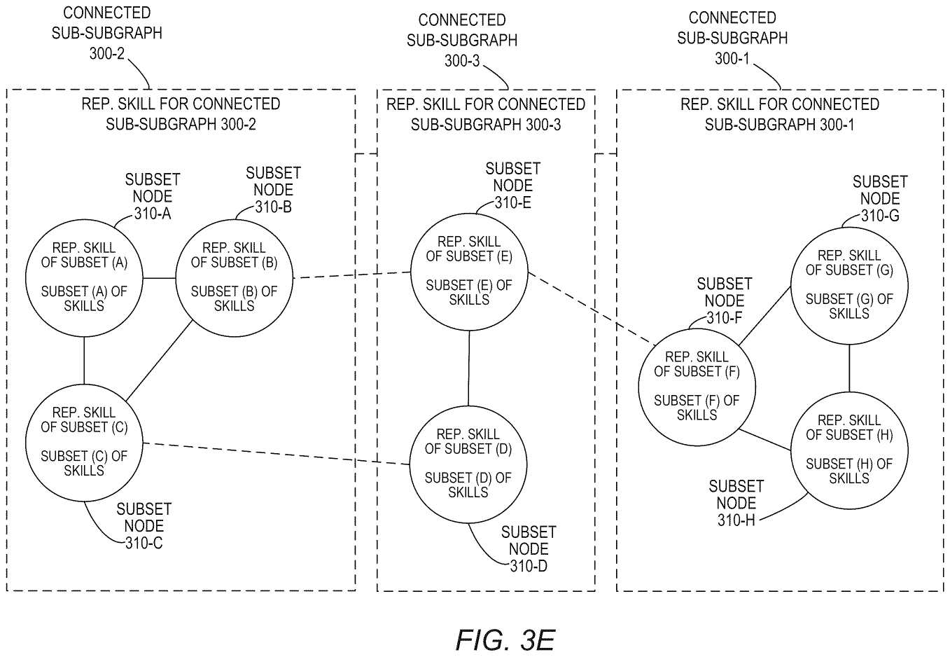

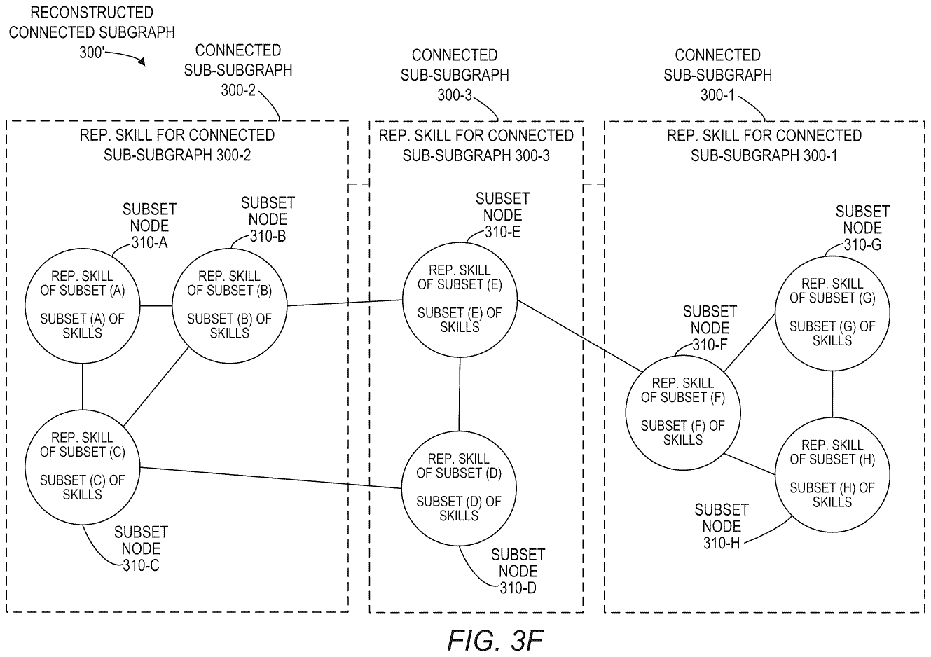

FIGS. 3A-3F illustrate an example of generating a skill hierarchy in accordance with one or more embodiments. In FIG. 3A, the system has generated a graph that includes a connected subgraph 300. The connected subgraph 300 includes nodes 310 that represent, respectively, different subsets of skills. For example, in FIG. 3A, node 310-A represents subset (A), node 310-B represents subset (B), node 310-C represents subset (C), node 310-D represents subset (D), node 310-E represents subset (E), node 310-F represents subset (F), node 310-G represents subset (G), and node 310-H represents subset (H). In this example, the system determines that the connected subgraph 300 exceeds a threshold number of nodes based on the connected subgraph 300 having 8 nodes and the threshold number of nodes being 3. As a result of this determination, the system executes a minimum cut operation to remove an edge of the connected subgraph 300. The location of this minimum cut is illustrated in FIG. 3A using a dotted line and the associated label “CUT.”

FIG. 3B shows the result of the minimum cut executed on the connected subgraph 300. As a result of this minimum cut, the connected subgraph 300 is split into two connected sub-subgraphs, connected sub-subgraph 300-1 and connected sub-subgraph 300-2. The removal of the edge that connected node 310-E and node 310-F is illustrated by a dotted line, and the relationship between the connected sub-subgraph 300-1 and the connected sub-subgraph 300-2 is illustrated by a dotted line. The connected sub-subgraph 300-1 has a total of 3 nodes: node 310-F, node 310-G, and node 310-H. The connected subgraph 300-2 has a total of 5 nodes: node 310-A, node 310-B, node 310-C, node 310-D, and node 310-E. Here, the system determines that the connected sub-subgraph 300-1 does not exceed the threshold number of nodes, but the connected sub-subgraph 300-2 does exceed the threshold number of nodes. As a result of this determination, the system executed the minimum cut operation to remove an edge of the connected sub-subgraph 300-2. The location of this cut is illustrated in FIG. 3B using a dotted line and the associated label “CUT.”

FIG. 3C shows the result of the minimum cut executed on the connected sub-subgraph 300-2. As a result of this minimum cut, the connected sub-subgraph 300-2 is split into two connected sub-subgraphs, connected sub-subgraph 300-2 and connected sub-subgraph 300-3. The removal of the edges that connected node 310-B to node 310-E and connected node 310-C to node 310-D is illustrated by respective dotted lines, and the relationship between the connected sub-subgraph 300-2 and the connected sub-subgraph 300-3 is illustrated by a dotted line. The connected sub-subgraph 300-2 has a total of 3 nodes: node 310-A, node 310-B, and node 310-C. The connected subgraph 300-3 has a total of 2 nodes: node 310-E and node 310-D. Here, the system determines that neither the connected sub-subgraph 300-2 nor the connected sub-subgraph 300-3 exceed the threshold number of nodes.

As a result of the determination that the connected sub-subgraphs 300-1, 300-2, and 300-3 do not exceed the threshold number of nodes, the system determines corresponding node-level representative skills for respective subsets of skills of the nodes 310. FIG. 3D shows the nodes 310 having corresponding node-level representative skills for the respective subsets of skills of the nodes 310.

Subsequent to the determination of the corresponding node-level representative skills, the system determines corresponding sub-subgraph-level representative skills for respective connected sub-subgraphs 300-1, 300-2, and 300-3. FIG. 3E shows the connected sub-subgraphs 300-1, 300-2, and 300-3 having corresponding sub-subgraph-level representative skills. The system determines the corresponding sub-subgraph-level representative skills based on the node-level representative skills of the corresponding nodes 310.

FIG. 3F shows the result of the system reconstructing the original connected subgraph 300, thereby forming a reconstructed original connected subgraph 300′. This reconstructing includes reconnecting nodes of the connected sub-subgraphs 300-1, 300-2, and 300-3 that were disconnected by the minimum cut. In FIG. 3F, the edge connecting node 310-E and node 310-F has been reconstructed, the edge connecting node 310-B and node 310-E has been reconstructed, and the edge connecting node 310-C and node 310-D has been reconstructed.

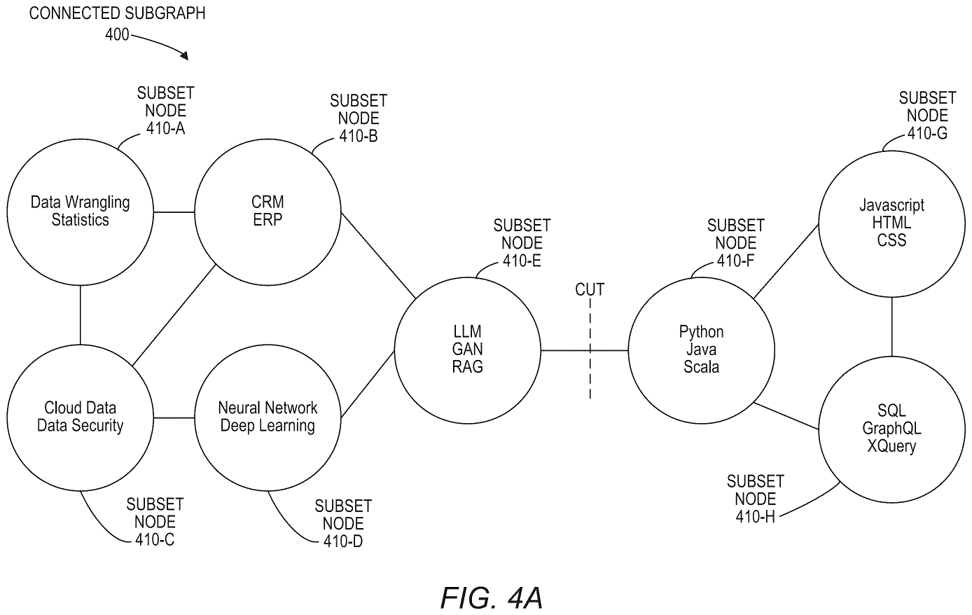

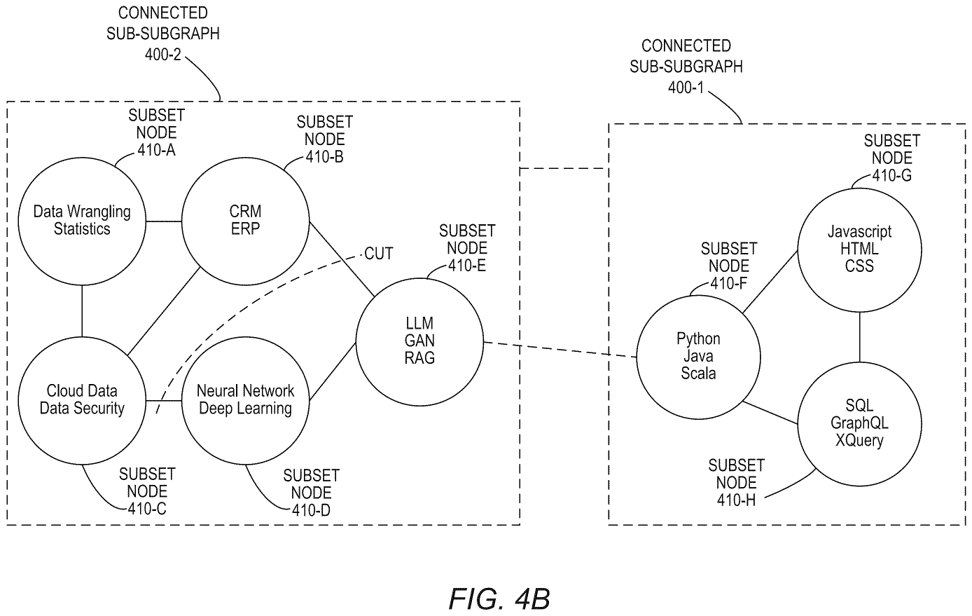

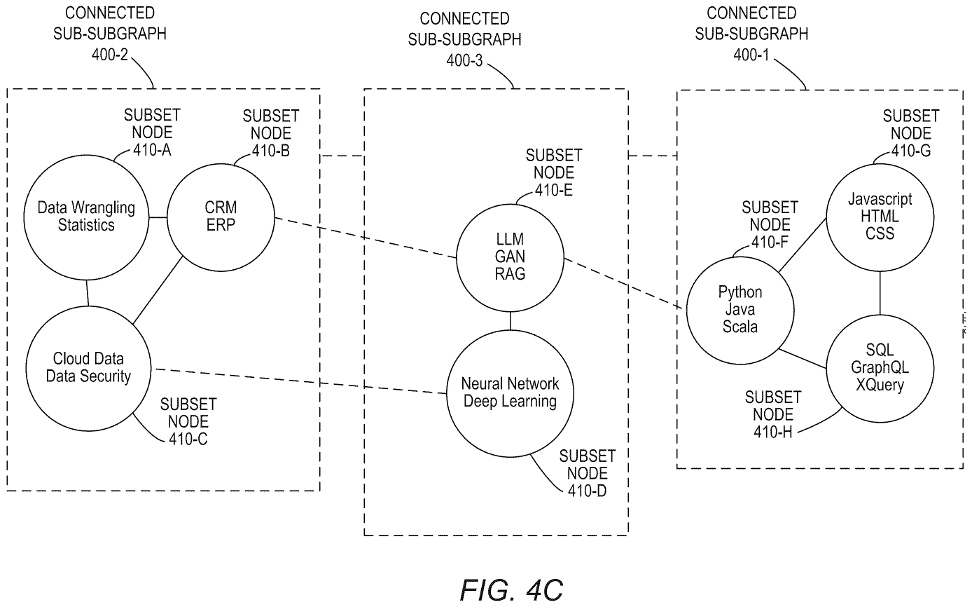

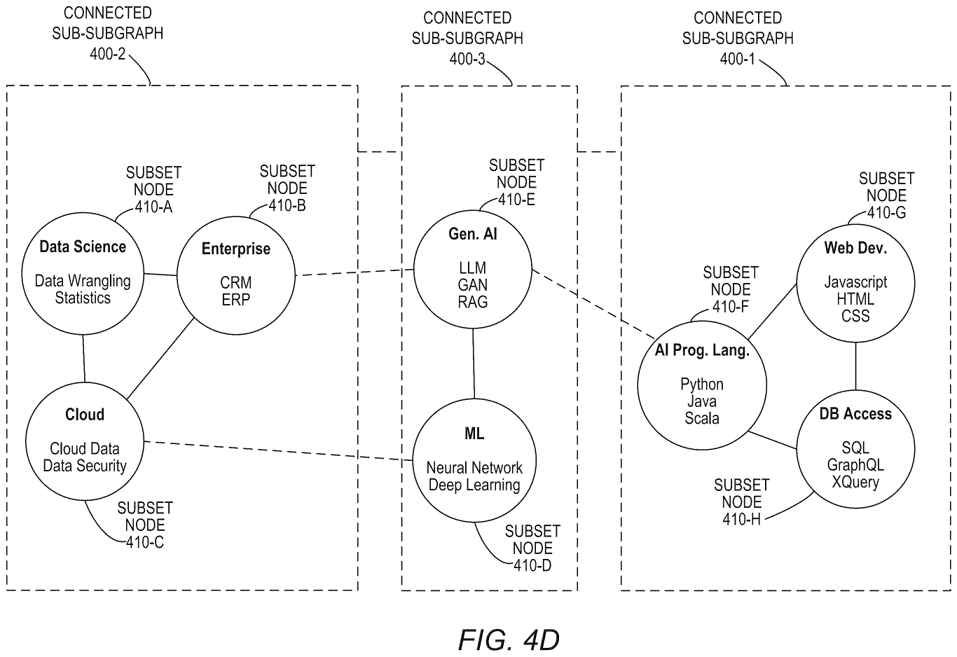

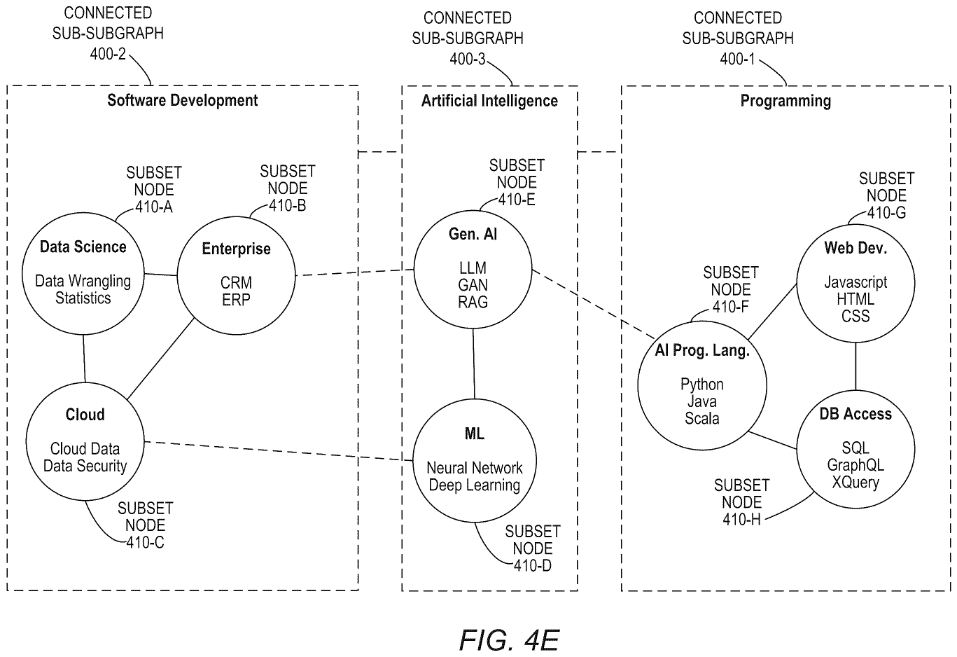

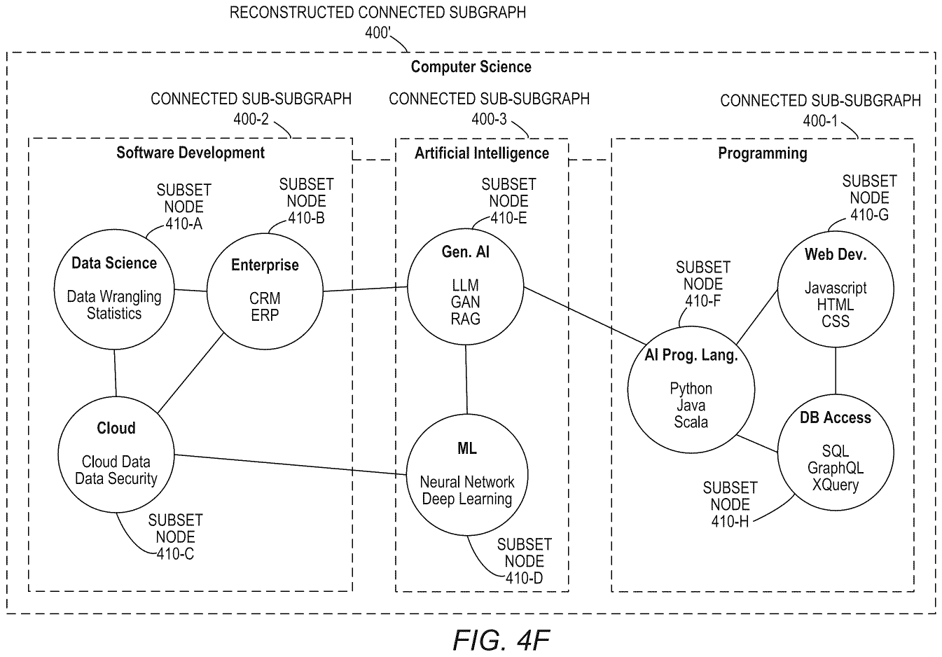

FIGS. 4A-4F illustrate another example embodiment of generating a skill hierarchy in accordance with one or more embodiments. In FIGS. 4A-4F, specific examples of skills are used to help explain the concepts of the present disclosure. In FIG. 4A, the system has generated a graph that includes a connected subgraph 400. The connected subgraph 400 includes nodes 410 that represent, respectively, different subsets of skills. For example, in FIG. 4A, node 410-A represents a subset of skills that includes Data Wrangling and Statistics, node 410-B represents a subset of skills that includes Customer Relationship Management (CRM) and Enterprise Resource Planning (ERP), node 410-C represents a subset of skills that includes Cloud Data and Data Security, node 410-D represents a subset of skills that includes Neural Network and Deep Learning, node 410-E represents a subset of skills that includes LLM, Generative Adversarial Network (GAN), and Retrieval-Augmented Generation (RAG), node 410-F represents a subset of skills that includes Python, Java, and Scala, node 410-G represents a subset of skills that includes JavaScript, Hypertext Markup Language (HTML), and Cascading Style Sheets (CSS), and node 410-H represents a subset of skills that includes Structured Query Language (SQL), GraphQL, and XQuery.

In the example shown in FIG. 4A, the system determines that the connected subgraph 400 exceeds a threshold number of nodes, based on the connected subgraph 400 having 8 nodes and the threshold number of nodes being 3. As a result of this determination, the system executes a minimum cut operation to remove an edge of the connected subgraph 400. The location of this minimum cut is illustrated in FIG. 4A using a dotted line and the associated label “CUT.”

FIG. 4B shows the result of the minimum cut executed on the connected subgraph 400. As a result of this minimum cut, the connected subgraph 400 is split into two connected sub-subgraphs, connected sub-subgraph 400-1 and connected sub-subgraph 400-2. The removal of the edge that connected node 410-E and node 410-F is illustrated by a dotted line, and the relationship between the connected sub-subgraph 400-1 and the connected sub-subgraph 400-2 is illustrated by a dotted line. The connected sub-subgraph 400-1 has a total of 3 nodes: node 410-F, node 410-G, and node 410-H. The connected subgraph 400-2 has a total of 5 nodes: node 410-A, node 410-B, node 410-C, node 410-D, and node 410-E. Here, the system determines that the connected sub-subgraph 400-1 does not exceed the threshold number of nodes, but the connected sub-subgraph 400-2 does exceed the threshold number of nodes. As a result of this determination, the system executed the minimum cut operation to remove an edge of the connected sub-subgraph 400-2. The location of this cut is illustrated in FIG. 4B using a dotted line and the associated label “CUT.”

FIG. 4C shows the result of the minimum cut executed on the connected sub-subgraph 400-2. As a result of this minimum cut, the connected sub-subgraph 400-2 is split into two connected sub-subgraphs, connected sub-subgraph 400-2 and connected sub-subgraph 400-3. The removal of the edges that connected node 410-B to node 410-E and connected node 410-C to node 410-D is illustrated by respective dotted lines, and the relationship between the connected sub-subgraph 400-2 and the connected sub-subgraph 400-3 is illustrated by a dotted line. The connected sub-subgraph 400-2 has a total of 3 nodes: node 410-A, node 410-B, and node 410-C. The connected subgraph 400-3 has a total of 2 nodes: node 410-E and node 410-D. Here, the system determines that neither the connected sub-subgraph 400-2 nor the connected sub-subgraph 400-3 exceed the threshold number of nodes.

As a result of the determination that the connected sub-subgraphs 400-1, 400-2, and 400-3 do not exceed the threshold number of nodes, the system determines corresponding node-level representative skills for respective subsets of skills of the nodes 410. FIG. 4D shows the nodes 410 having corresponding node-level representative skills for the respective subsets of skills of the nodes 410. In the example shown in FIG. 4D, the node-level representative skill for the subset of skills of node 410-A is Data Science, the node-level representative skill for the subset of skills of node 410-B is Enterprise, the node-level representative skill for the subset of skills of node 410-C is Cloud, the node-level representative skill for the subset of skills of node 410-D is Machine Learning (ML), the node-level representative skill for the subset of skills of node 410-E is Generative AI, the node-level representative skill for the subset of skills of node 410-F is AI Programming Languages, the node-level representative skill for the subset of skills of node 410-G is Web Development, and the node-level representative skill for the subset of skills of node 410-H is Database (DB) Access.

Subsequent to the determination of the corresponding node-level representative skills, the system determines corresponding sub-subgraph-level representative skills for respective connected sub-subgraphs 400-1, 400-2, and 400-3. FIG. 4E shows the connected sub-subgraphs 400-1, 400-2, and 400-3 having corresponding sub-subgraph-level representative skills. The system determines the corresponding sub-subgraph-level representative skills based on the node-level representative skills of the corresponding nodes 410. In the example shown in FIG. 4E, the sub-subgraph-level representative skill for the connected sub-subgraph 400-1 is Programming, the sub-subgraph-level representative skill for the connected sub-subgraph 400-2 is Software Development, and the sub-subgraph-level representative skill for the connected sub-subgraph 400-3 is Artificial Intelligence.

FIG. 4F shows the result of the system reconstructing the original connected subgraph 400, thereby forming a reconstructed original connected subgraph 400'. This reconstructing includes reconnecting nodes of the connected sub-subgraphs 400-1, 400-2, and 400-3 that were disconnected by the minimum cut. In FIG. 4F, the edge connecting node 410-E and node 410-F has been reconstructed, the edge connecting node 410-B and node 410-E has been reconstructed, and the edge connecting node 410-C and node 410-D has been reconstructed.

### 5. COMPUTER NETWORKS AND CLOUD NETWORKS

In an embodiment, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In an embodiment, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In an embodiment, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In an embodiment, the trigger, when satisfied, might output data for consumption by the target microservice. Additionally or alternatively, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In an embodiment, a plugged-in microservice application may expose actions to the microservices manager. The exposed actions may receive, as input, data or an identification of a data object or location of data, that causes data to be moved into a data cloud.

In an embodiment, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In an embodiment, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

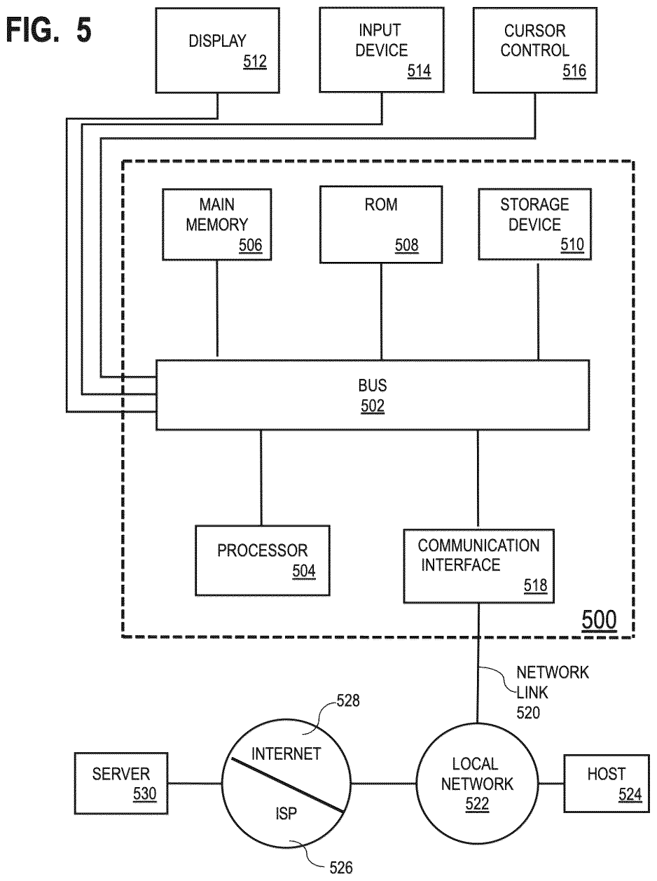

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions included in main memory 506. Such instructions may be read into main memory 506 from another storage medium, such as storage device 510. Execution of the sequences of instructions included in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
generating a graph that models a plurality of skills, at least by:
adding, to the graph, a first node that represents a first subset of the plurality of skills and a second node that represents a second subset of the plurality of skills;
determining, using a first model, that the first node and the second node are candidates to be connected by a first edge in the graph; and
verifying, using a second model comprising a large language model (LLM), that the first node and the second node satisfy one or more similarity criteria for including the first edge between the first node and the second node;
responsive to determining that a connected subgraph of the graph, comprising the first node and the second node, exceeds a threshold number of nodes: performing a minimum cut of the connected subgraph, to obtain (a) a first connected sub-subgraph comprising the first node and the second node and (b) a second connected sub-subgraph;
responsive to determining that the first connected sub-subgraph does not exceed the threshold number of nodes:
determining, using a first generative artificial intelligence (AI) model, (a) a first node-level representative skill for the first node and (b) a second node-level representative skill for the second node; and
determining, using a second generative AI model, a first sub-subgraph-level representative skill based at least in part on the first node-level representative skill and the second node-level representative skill; and
generating a skill hierarchy comprising (a) the first sub-subgraph-level representative skill and (b) the first node-level representative skill and the second node-level representative skill as children of the first sub-subgraph-level representative skill;
wherein the method is performed by at least one device including a hardware processor.

2. The method of claim 1, wherein the first model is not an LLM.

3. The method of claim 1, wherein determining that the first node and the second node are candidates to be connected by the first edge in the graph comprises:
determining, using the first model, a similarity metric for the first node and the second node; and
determining that the similarity metric satisfies a threshold criterion.

4. The method of claim 3, wherein determining the similarity metric comprises:
generating a first vector embedding for the first node and a second vector embedding for the second node; and
generating the similarity metric based at least in part on the first vector embedding and the second vector embedding.

5. The method of claim 1, wherein generating the graph further comprises:
determining, using the second model, that a third node of the graph and a fourth node of the graph do not satisfy the one or more similarity criteria; and
responsive to determining that the third node of the graph and the fourth node of the graph do not satisfy the one or more similarity criteria: refraining from adding, to the graph, a second edge between the third node and the fourth node.

6. The method of claim 1, wherein generating the graph further comprises:
responsive to determining that skills in the first subset of the plurality of skills satisfy a group similarity criterion: generating the first node that represents the first subset of the plurality of skills; and
responsive to determining that skills in the second subset of the plurality of skills satisfy the group similarity criterion: generating the second node that represents the second subset of the plurality of skills.

7. The method of claim 1, further comprising:
determining, by a human capital management (HCM) system, if a user profile managed by the HCM system identifies a particular skill in the skill hierarchy; and
based at least in part on determining if the user profile identifies the particular skill: performing, by the HCM system, one or more skill-related HCM functions associated with the user profile.

8. The method of claim 1, wherein generating the skill hierarchy comprises:
reconstructing the first connected subgraph by reconnecting nodes of the first connected sub-subgraph and the second connected sub-subgraph that were disconnected by the minimum cut of the first connected subgraph.

9. The method of claim 8, wherein generating the skill hierarchy further comprises:
determining, using a third generative AI model, a subgraph-level representative skill for the reconstructed first connected subgraph, based at least in part on (a) the first sub-subgraph-level representative skill and (b) a second sub-subgraph-level representative skill for the second connected sub-subgraph; and
adding, to the skill hierarchy, the subgraph-level representative skill as a parent of the first sub-subgraph-level representative skill and the second sub-subgraph-level representative skill.

10. One or more non-transitory computer readable media comprising instructions which, when executed by one or more hardware processors, cause performance of operations comprising:
generating a graph that models a plurality of skills, at least by:
adding, to the graph, a first node that represents a first subset of the plurality of skills and a second node that represents a second subset of the plurality of skills;
determining, using a first model, that the first node and the second node are candidates to be connected by a first edge in the graph; and
verifying, using a second model comprising a large language model (LLM), that the first node and the second node satisfy one or more similarity criteria for including the first edge between the first node and the second node;
responsive to determining that a connected subgraph of the graph, comprising the first node and the second node, exceeds a threshold number of nodes: performing a minimum cut of the connected subgraph, to obtain (a) a first connected sub-subgraph comprising the first node and the second node and (b) a second connected sub-subgraph;
responsive to determining that the first connected sub-subgraph does not exceed the threshold number of nodes:
determining, using a first generative artificial intelligence (AI) model, (a) a first node-level representative skill for the first node and (b) a second node-level representative skill for the second node; and
determining, using a second generative AI model, a first sub-subgraph-level representative skill based at least in part on the first node-level representative skill and the second node-level representative skill; and
generating a skill hierarchy comprising (a) the first sub-subgraph-level representative skill and (b) the first node-level representative skill and the second node-level representative skill as children of the first sub-subgraph-level representative skill.

11. The one or more non-transitory computer readable media of claim 10, wherein the first model is not an LLM.

12. The one or more non-transitory computer readable media of claim 10, wherein determining that the first node and the second node are candidates to be connected by the first edge in the graph comprises:
determining, using the first model, a similarity metric for the first node and the second node; and
determining that the similarity metric satisfies a threshold criterion.

13. The one or more non-transitory computer readable media of claim 12, wherein determining the similarity metric comprises:
generating a first vector embedding for the first node and a second vector embedding for the second node; and
generating the similarity metric based at least in part on the first vector embedding and the second vector embedding.

14. The one or more non-transitory computer readable media of claim 10, wherein generating the graph further comprises:
determining, using the second model, that a third node of the graph and a fourth node of the graph do not satisfy the one or more similarity criteria; and
responsive to determining that the third node of the graph and the fourth node of the graph do not satisfy the one or more similarity criteria: refraining from adding, to the graph, a second edge between the third node and the fourth node.

15. The one or more non-transitory computer readable media of claim 10, wherein generating the graph further comprises:
responsive to determining that skills in the first subset of the plurality of skills satisfy a group similarity criterion: generating the first node that represents the first subset of the plurality of skills; and
responsive to determining that skills in the second subset of the plurality of skills satisfy the group similarity criterion: generating the second node that represents the second subset of the plurality of skills.

16. A system comprising:
at least one device including a hardware processor;
the system being configured to perform operations comprising:
generating a graph that models a plurality of skills, at least by:
adding, to the graph, a first node that represents a first subset of the plurality of skills and a second node that represents a second subset of the plurality of skills;
determining, using a first model, that the first node and the second node are candidates to be connected by a first edge in the graph; and
verifying, using a second model comprising a large language model (LLM), that the first node and the second node satisfy one or more similarity criteria for including the first edge between the first node and the second node;
responsive to determining that a connected subgraph of the graph, comprising the first node and the second node, exceeds a threshold number of nodes: performing a minimum cut of the connected subgraph, to obtain (a) a first connected sub-subgraph comprising the first node and the second node and (b) a second connected sub-subgraph;
responsive to determining that the first connected sub-subgraph does not exceed the threshold number of nodes:
determining, using a first generative artificial intelligence (AI) model, (a) a first node-level representative skill for the first node and (b) a second node-level representative skill for the second node; and
determining, using a second generative AI model, a first sub-subgraph-level representative skill based at least in part on the first node-level representative skill and the second node-level representative skill; and
generating a skill hierarchy comprising (a) the first sub-subgraph-level representative skill and (b) the first node-level representative skill and the second node-level representative skill as children of the first sub-subgraph-level representative skill.

17. The system of claim 16, wherein the first model is not an LLM.

18. The system of claim 16, wherein determining that the first node and the second node are candidates to be connected by the first edge in the graph comprises:
determining, using the first model, a similarity metric for the first node and the second node; and
determining that the similarity metric satisfies a threshold criterion.

19. The system of claim 18, wherein determining the similarity metric comprises:
generating a first vector embedding for the first node and a second vector embedding for the second node; and
generating the similarity metric based at least in part on the first vector embedding and the second vector embedding.

20. The system of claim 16, wherein generating the graph further comprises:
determining, using the second model, that a third node of the graph and a fourth node of the graph do not satisfy the one or more similarity criteria; and
responsive to determining that the third node of the graph and the fourth node of the graph do not satisfy the one or more similarity criteria: refraining from adding, to the graph, a second edge between the third node and the fourth node.
